(19) United States
(12) Patent Application Publication
(10) Pub. No.: US 2026/0128046 A1
(43) Pub. Date: May 7, 2026

(54) SOURCE SEPARATING MULTI-STREAM AUDIO CODEC WITH CUSTOMIZABLE FILTERING AND MIXING

(71) Applicant: Cisco Technology, Inc., San Jose, CA (US)

(72) Inventors: Yusuf Ziya Isik, Edinburgh (GB); Christopher Rowen, Santa Cruz, CA (US); Samer Lutfi Hijazi, San Jose, CA (US); Xuehong Mao, San Jose, CA (US)

(21) Appl. No.: 18/937,239

(22) Filed: Nov. 5, 2024

(51) Int. Cl. G10L 19/038; G10L 19/002; G10L 21/0272; G10L 25/30

(52) U.S. Cl. CPC G10L 19/038; G10L 19/002; G10L 21/0272; G10L 25/30

(57) ABSTRACT

A method of operating an audio transmitting endpoint includes receiving an audio signal at a transmitting endpoint, using a trained neural network, source separating the audio signal to generate a first source stream comprising first embedding vectors representative of a first source of the audio signal and a second source stream comprising second embedding vectors representative of a second source of the audio signal, adjusting an allocation of bandwidth for at least one of the first and second source streams based on at least one of entropy and dynamism of the at least one of the first and second streams, applying at least one transformation operation to at least one of the first second source streams, vector quantizing the first and second source streams to generate first and second codewords, and transmitting, in one or more packets, the first and second codewords, or respective indexes thereof, to a remote endpoint.

### TECHNICAL FIELD

The present disclosure relates to audio processing, and more particularly to audio processing using a neural audio coding-decoding system that performs source separation.

### BACKGROUND

Audio coding/decoding (codec) systems play a role in real-time communication technologies, aiming to preserve audio content quality and intelligibility while minimizing bit consumption. The integration of machine learning techniques and the development of end-to-end neural codecs have driven advancements in bitrate reduction and audio quality.

In addition to encoding the audio signal, there is a role for audio enhancement in extensively utilized real-time communication solutions. Deep neural networks have shown promising results in addressing the challenges of audio enhancement in noisy and reverberant environments.

### BRIEF DESCRIPTION OF THE DRAWINGS

FIG. 1 is a system block diagram of a neural network audio codec system according to an example embodiment.

FIG. 2 is a diagram depicting end-to-end training of a neural network audio codec system according to an example embodiment.

FIG. 3 is a block diagram of a transmitting endpoint of a neural network audio codec system according to an example embodiment.

FIG. 4 shows a user interface for controlling a transmitting endpoint or a receiving endpoint of a neural network audio codec system according to an example embodiment.

FIG. 5 is a block diagram of a receiving endpoint of a neural network audio codec system according to an example embodiment.

FIG. 6 is a flowchart depicting a series of operations that may be executed by a transmitting endpoint in connection with source separating and control logic, according to an example embodiment.

FIG. 7 is a block diagram of a computing device that may be configured to host location management function logic, and to perform techniques described herein, according to an example embodiment.

### DETAILED DESCRIPTION

### Overview

A method of operating an audio transmitting endpoint is disclosed. The method may include receiving an audio signal at a transmitting endpoint, using a trained neural network, source separating the audio signal to generate a first source stream comprising first embedding vectors representative of a first source of the audio signal and a second source stream comprising second embedding vectors representative of a second source of the audio signal, adjusting an allocation of bandwidth for at least one of the first source stream and the second source stream based on at least one of entropy and dynamism of the at least one of the first source stream and the second source stream, applying at least one transformation operation to at least one of the first source stream and the second source stream, vector quantizing the first source stream to generate first codewords, vector quantizing the second source stream to generate second codewords, and transmitting, in one or more packets, the first codewords and the second codewords, or respective indexes thereof, to a remote endpoint.

A device is also described and includes an interface configured to enable network communications, a memory, and one or more processors coupled to the interface and the memory, and configured to: receive an audio signal, using a trained neural network, source separate the audio signal to generate a first source stream comprising first embedding vectors representative of a first source of the audio signal and a second source stream comprising second embedding vectors representative of a second source of the audio signal, adjust an allocation of bandwidth for at least one of the first source stream and the second source stream based on at least one of entropy and dynamism of the at least one of the first source stream and the second source stream, apply at least one transformation operation to at least one of the first source stream and the second source stream, vector quantize the first source stream to generate first codewords, vector quantize the second source stream to generate second codewords, and transmit, in one or more packets, the first codewords and the second codewords, or respective indexes thereof, to a remote endpoint.

### Example Embodiments

### Neural Network Audio Codec System

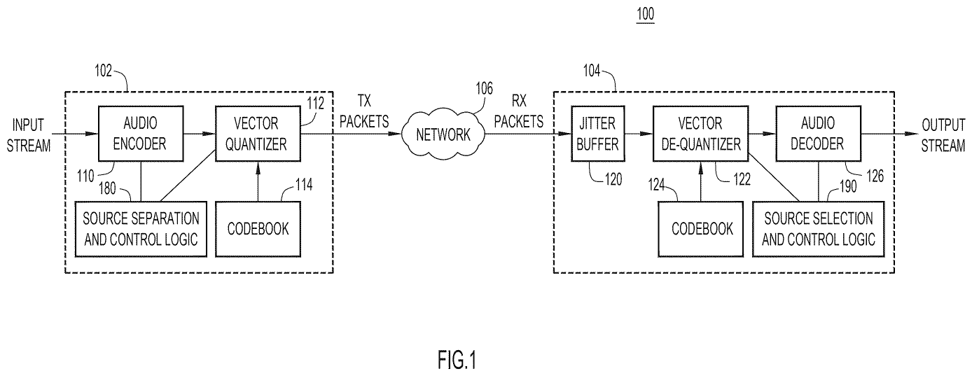

Reference is first made to FIG. 1. FIG. 1 shows a block diagram of a neural audio encoder/decoder (codec) system 100. The neural audio codec system 100 includes a transmit side 102 and a receive side 104, which may be separate at devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments, such as background noise). The audio encoder 110 may use a deep neural network that takes the input audio stream and transforms it, frame-by-frame, into high-dimensional embedding vectors that keep all the important information and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. The vector quantizer 112 quantizes the high-dimensional vectors at the output of the audio encoder 110, called embedding vectors herein. For example, the vector quantizer 112 may use techniques such as Residual Vector Quantization by selecting a set of codewords (from the codebook 114) from each layer to optimize a criterion reducing quantization error at the output stream on receive side. The indices of the selected codewords for each frame are put into transmit (TX) packets and sent to the receive side 104, or they may be stored for later retrieval and use. In some implementations, the audio encoder 110 may generate the quantized vectors (indices) directly without the need for a separate vector quantizer 112.

As noted, the audio encoder 110 may use a deep neural network that takes the input audio stream and transforms it, frame-by-frame, into high-dimensional embedding vectors that keep all the important information and optionally removes unwanted information such as the artifacts and impairments. In this regard, source separating (or separation) and control logic 180 may be employed to separate out “unwanted information” into respective streams. For example, and as will be explained in more detail further below, source separating and control logic 180 may be configured to generate a first stream comprising embedding vectors that represent substantially only a main speaker and a second stream comprising embedding vectors that represent substantially only background music (or other noise). Each of the resulting streams may then be processed separately, before being transmitted, if at all, to the receive side 104.

The receive side 104 obtains receive (RX) packets from the network 106. At the receive side 104, there are a jitter buffer 120, vector de-quantizer 122, codebook 124 and an audio decoder 126. The jitter buffer 120 keeps track of the incoming packets, putting them in order and deciding when to process and play a packet. The jitter buffer 120 may also be used to detect packet loss. The vector de-quantizer 122 de-quantizes received codeword indices and using the codebook 124, outputs recovered embedding vectors. The audio decoder 126 decodes the embedding vectors to produce an output audio stream.

Also shown is source selection and control logic 190 that is configured, in accordance with an embodiment, to process respective incoming separate streams from transmit side 102. As will be explained below, such process may include separately de-quantizing, and selected which of the individual streams are to be played for a listener.

Though not specifically shown in FIG. 1, there may be an encoder, vector quantizer, vector de-quantizer and decoder at each device to enable two-way communications.

Techniques are provided for a generative artificial intelligence (AI) architecture built on the neural audio codec system 100 shown in FIG. 1. At the core of this architecture is a compact speech vector that has great potential for a wide range of speech AI and other applications. The proposed unified architecture offers a versatile solution applicable to various content, including but not limited to: speech enhancement (such as background noise removal, de-reverberation, speech super-resolution, bandwidth extension, gain control, and beamforming), packet loss concealment (with or without forward error correction (FEC)), acoustic speech recognition (ASR), speech synthesis, also referred to as text-to-speech (TTS), voice cloning and morphing, speech-to-speech translation (S2ST), and audio-driven large language model (AdLLR).

### Training the Neural Network Audio Codec System

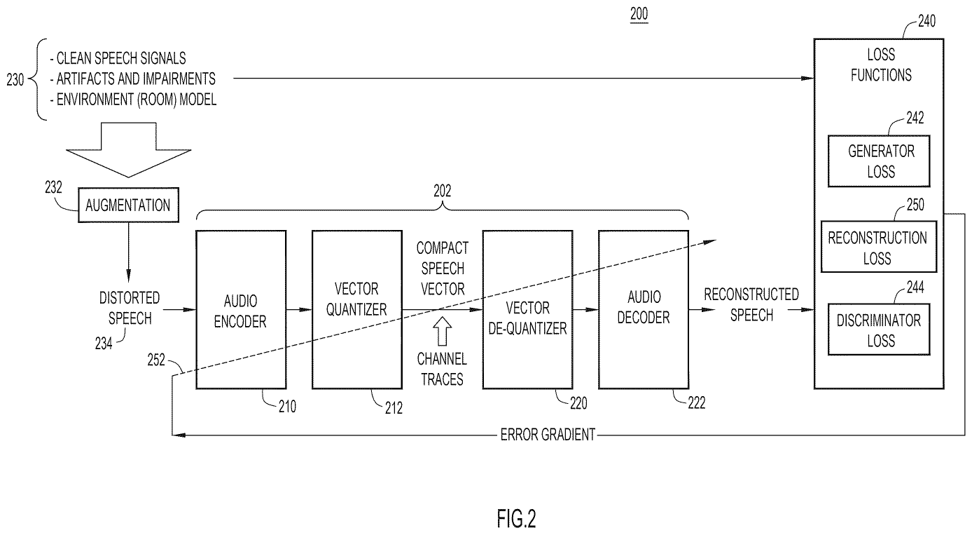

Reference is now made to FIG. 2. FIG. 2 shows an arrangement 200 by which components of a neural audio codec system 202 are trained end-to-end using thousands of hours of speech and artifacts and impairments. Similar to FIG. 1, the neural audio codec system 202 includes an audio encoder 210, vector quantizer 212, vector de-quantizer 220 and audio decoder 222, and each of these components may use a neural network model (or more generally machine learning-based model) for their operations.

To train the neural audio codec system 202, and as shown at reference numeral 230, various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the neural audio codec system 202.

The training process involves applying loss functions 240 to the reconstructed speech that is output by the audio decoder 222. The loss functions 240 may include a generative loss function 242, a reconstruction loss function 250, and an adversarial/discriminator loss function 244. The loss functions 240 output an error gradient that is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features, whereas in the embodiments presented herein, the neural audio codec systems learns and refines its feature extraction process from extensive and diverse datasets, resulting in a more versatile and generalized representation.

The output of the audio encoder 210 materializes as a series of embedding vectors, with each vector encapsulating a snapshot of audio attributes over a timeframe. The vector quantizer 212 further compresses the embedding vector into a compact speech vector, i.e., codewords, using a residual vector quantization (RVQ) model. Vector quantizer 212 may also be implanted using product vector quantization, also known as group vector quantization. Such an approach employs multiple layers, but unlike RVQ, each layer works in parallel. The embodiments described herein are not limited to any particular quantizer implementation. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” to recover speech but discarding, or separating out, anything else related to artifacts or impairments. Thus, for speech enhancement applications, the neural audio codec system does not encode audio, but rather, encodes, individually, speech, music, background noise, etc. In so doing, the neural audio codec system can produce a richer and customizable experience for both the transmit side 102 and the receive side 104.

### Loss Functions Useful During Training

Reconstruction losses may be used to minimize the error between the clean signal, known as a target signal, x and an enhanced signal generated by the neural audio codec, denoted \hat{x}, which is denoised and dereverberated and/or with concealed packets/frames loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x time domain:

$${ℒ}_{𝔱} = {\sum }_{n = 1}^{N} \vert x [ n ] - \hat{x} [ n ] \vert ,$$

where [symbol] ₜ is the L1 norm loss and N denotes to number of samples of \hat{x} and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{S D R} ( x , \hat{x} ) = - \frac{〈 x , \hat{x} 〉}{‖ x ‖ ‖ \hat{x} ‖} ,$$

where the operator [symbol] represents the inner product and ∥, ∥ represents Euclidean norm. This loss is phase sensitive with the range [−1,1]. For noise only samples, to be more precise, a noise prediction term is added to define the final weighted SDR loss:

$${ℒ}_{S D R} ( x , n , \hat{n} ) = {ℒ}_{S D R} ( x , \hat{x} ) + {ℒ}_{S D R} ( n , \hat{n} ) ,$$

where \hat{n}=y−\hat{x} is estimated noise.

Multi-scale Short-Time Fourier Transform (MS STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS STFT uses a range of window lengths to capture different features of the audio waveform.

The loss is defined as:

$${ℒ}_{MSTFT} = {Σ}_{l = 1}^{L} {Σ}_{k = 1}^{K} \vert {S}^{w} [ l , k ] - {\hat{S}}^{w} [ l , k ] \vert + {α}_{w} {Σ}_{l = 1}^{L} {Σ}_{k = 1}^{K} \sqrt{{\vert log ( {S}^{w} [ l , k ] ) - log ( {\hat{S}}^{w} [ l , k ] ) \vert}^{2}} ,$$

where S^{w}[l, k] is the energy of the spectrogram at frame l and frequency bin k and characterized by a window w, K is the number of frequency bins, L is the number of frames and α_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

The power spectrum of the signal is computed as below:

$$P ( X ) = 1 / N {\sum }_{n = 0}^{N - 1} {\vert {X}_{n} \vert}^{2} ,$$

where P(x) is the mean power spectrum of signal x, X is FFT/STFT of signal x.

A logarithm may be applied to the mean power spectrum (MPS), such that the logarithmic power spectrum of a signal x is:

$$L ( x ) = 10 {log}_{10} ( P ( x ) + ϵ ) ,$$

where ϵ is a small constant to prevent the logarithm of zero.

The MPS loss between the enhanced and clean signals can then be defined as the L2 Norm of the difference between their logarithmic power spectra:

$${ℒ}_{MPS} ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural audio codec system: Lease-squared adversarial loss functions and hinge loss functions.

Least square (LS) loss functions for discriminator and generator may be respectively defined as:

$${ℒ}_{ADV} ( D ; G ) = {E}_{( x , s )} [ {( D ( x ) - 1 )}^{2} + {D ( G ( y ) )}^{2} ] ,$$

$${ℒ}_{ADV} ( G ; D ) = {E}_{d} [ {D ( G ( y ) - 1 )}^{2} ] ,$$

For discriminator loss, [symbol] _{ADV}(D; G), E_{(,)} is the expectation operator, D(x), is the output of the discriminator for a real signal x, D(G(y)) is the discriminator output of enhanced (fake) signal and [symbol] _{ADV}(G; D) is the generator loss.

Hinge loss for the discriminator and generator may be defined as:

$${ℒ}_{ADV} ( D ; G ) = {E}_{( x , y )} [ max ( 1 - D ( x ) , 0 ) + max ( 0 , 1 + D ( G ( y ) ) ) ] ,$$

$${ℒ}_{ADV} ( G ; D ) = {E}_{y} [ max ( 1 - D ( G ( y ) ) , 0 ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{F M} ( G ; D ) = {E}_{( x y )} [ {\sum }_{i = 1}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyzes the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a n×m kernel size and c number of channels, followed by a Leaky ReLu non-linear activation function. Subsequent 2D convolution layers have dilation rates in the temporal dimension and an output stride of j across the frequency axis. At the end we have d×d convolution with stride 1 followed by flatten layer to get the output scores.

Finally, the total loss of adversarial training may be defined as:

$$ℒ = {λ}_{FM} {ℒ}_{FM} + {λ}_{MSTFT} {ℒ}_{MSTFT} + {λ}_{G} {ℒ}_{ADV} ( G ; D ) + {λ}_{D} {ℒ}_{ADV} ( D ; G ) + {λ}_{t} {ℒ}_{t} + {λ}_{SDR} {ℒ}_{SDR} + {λ}_{MPS} {ℒ}_{MPS} ,$$

where λ coefficients are used to give more weights to some losses compared to the other losses, [symbol] _{FM} is the feature matching loss. [symbol] _{MSTFT} is MS-STFT loss that can be replaced by [symbol] _{MSD} for MSD discriminator or [symbol] _{MPD} for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

### Source Separation and Control

In one possible implementation, and as suggested by FIG. 1, the input audio is encoded and quantized in a single stream and sent to the receive side 104. To enhance a user's experience, the embodiments described herein implement source separation, implemented in conjunction with source separating and control logic 180, as part of the encoding process to separate individual audio sources such as a main talker, a far field talker, background music, background noise, etc., into separate streams. As will be explained more fully below, source separation makes it possible to separately process the individual streams, including separately filtering, transforming, quantizing and allocating bandwidth to each stream based on the information content of each given stream, user preferences, co-occurrence with other sources, and quality policies. As a result, source separation enables customizable filtering, mixing and transform operations for improved user experience.

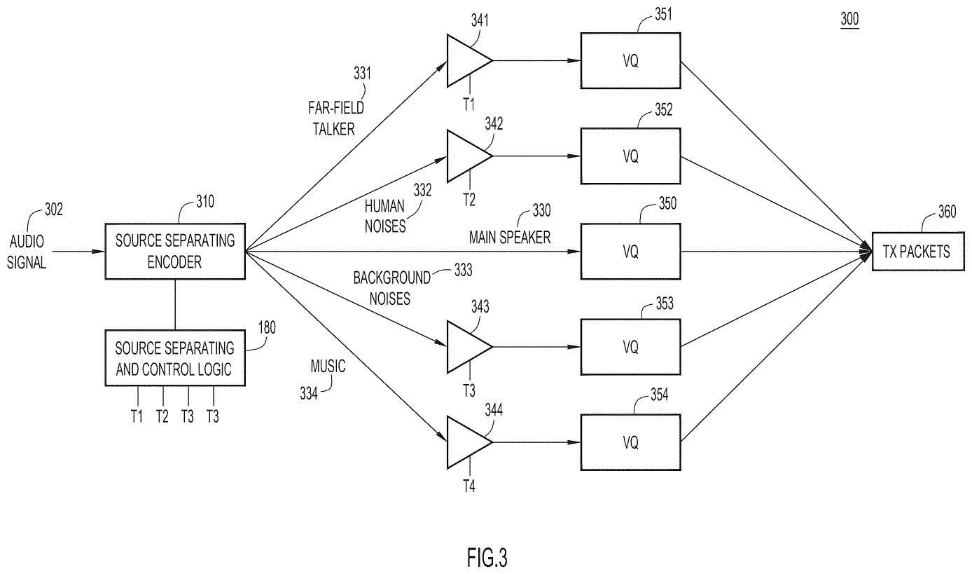

FIG. 3 is a block diagram of a transmitting endpoint 300 of a neural network audio codec system that implements source separation, or separating, according to an example embodiment. Here, a source separating encoder 310, operating in conjunction with source separating and control logic 180, is configured, using a previously-trained neural network, to separate different sources of audio from an audio signal 302. In the example shown, five distinct sources, or types of content, are separated into independent streams: a main speaker stream 330, a far-field talker stream 331, a human noises stream 332, a background noises stream 333, and a music stream 334.

Notably, and in accordance with an embodiment, source separating is performed in the latent domain, i.e., the embedding domain, based on the content of the audio. That is, the audio signal 302 is encoded by neural network-based source separating encoder 310 into a series of embedding vectors. The neural network, trained, e.g., in accordance with the discussion of FIG. 2, is configured to operate on the embedding vectors to separate audio signal 302 into several independent streams such as main speaker stream 330, far-field talker stream 331, human noises stream 332, background noises stream 333, and music stream 334 based on the respective stream content, as shown in FIG. 3. Then, each of these streams may be independently processed or transformed via at least one filter 341, 342, 343, 344 to, among other possibilities, adjust temporal and spectral characteristics, a tone or volume of the given stream. Note that in FIG. 3 the main speaker stream 330 does not include its own filter, but a filter or other form of audio processor could be also be implemented in the path of main speaker stream 330.

As shown, each stream is then passed to respective vector quantizers 350, 351, 352, 353, 354 for compression using, e.g., an appropriate codebook associated with each given stream (content type), to assign an appropriate codeword and index. A single codebook, that is applicable to each stream, could also be implemented. Output from vector quantizers 350, 351, 352, 353, 354 may be tagged with a flag or indicator identifying the stream with which that output is associated. The output may then be transmitted as TX packets 360 directly to a remote endpoint or to an intermediate server (not shown).

As shown in FIG. 3, each of the filters 341, 342, 343, 344 may be controlled with a respective transmit control signal T1, T2, T3, T4. In an embodiment, each transmit control signal T1, T2, T3, T4 may be custom controlled by a user of transmitting endpoint 300.

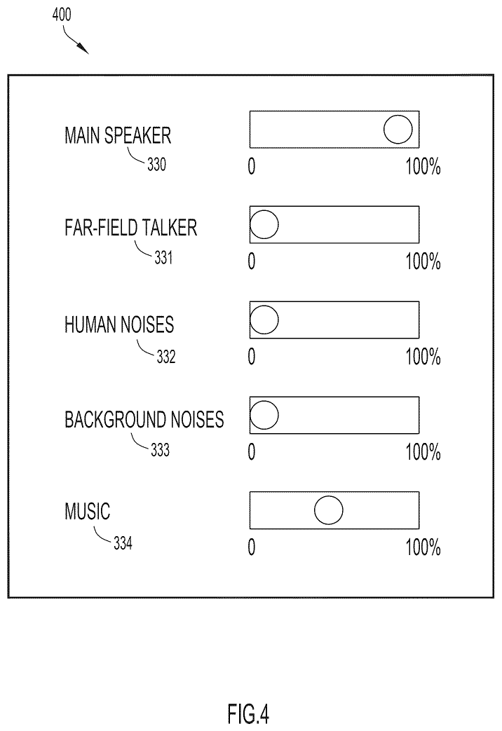

More specifically, FIG. 4 shows a user interface 400 for controlling a transmitting endpoint of a neural network audio codec system according to an example embodiment. User interface 400 may be generated by source separating and control logic 180 and may be presented to a user via a terminal, computer, smartphone, etc. via which the user may be participating in an audio/video conference. In the example of FIG. 4, a user may be presented with slide controls to control the volume (and/or tone) of each stream that was separated by source separating encoder 310. In this case, the volume (and/or tone) of the same main speaker stream 330 (assuming a filter is supplied for this stream), a far-field talker stream 331, a human noises stream 332, a background noises stream 333, and a music stream 334 are controllable. That is, a user at the transmit side can select which streams, and how selected streams, are transmitted to a receiver or remote endpoint.

In the event one or more streams are selected not to be transmitted, such as far-field talker stream 331, a human noises stream 332, a background noises stream 333 as illustrated in FIG. 4 with volume set to zero, then there is increased bandwidth available to transmit the remaining streams. For example, assume a total bandwidth of 10 kbps is available and is allocated with 6 kbps to the main speaker, 3 kbps to music, and 1 kbps for human noises. If a user elects to eliminate from transmission both the music and human noises, then 10 kbps is available and may be allocated to main speaker stream 330. Thus, increased fidelity or sound quality may be possible for streams selected to be transmitted when other streams are not transmitted.

Further, if transmitting endpoint 300 learns that a channel condition between transmitting endpoint 300 and a remote endpoint is unstable and/or packet loss is occurring/detected, source separating and control logic 180 may be configured to automatically stop transmitting selected sources and allocate an increased amount of available bandwidth to, e.g., main speaker stream 330.

In another possible scenario, the main speaker in the audio/video conference may have stopped talking. In such as case, source separating and control logic 180 may be configured to allocate bandwidth to other sources until audio from the main speaker is again detected.

More generally, as part of the quantization (or prior to quantization), the entropy and dynamism (how fast/slow the signal is changing) of a source may be calculated and the bitrate or bandwidth allocated for that source may be decided based on the information content or user preferences. In adverse network conditions some of the sources could be dropped or quantized at a lower bitrate to reduce bandwidth. These calculations and allocations may be executed by source separating and control logic 180.

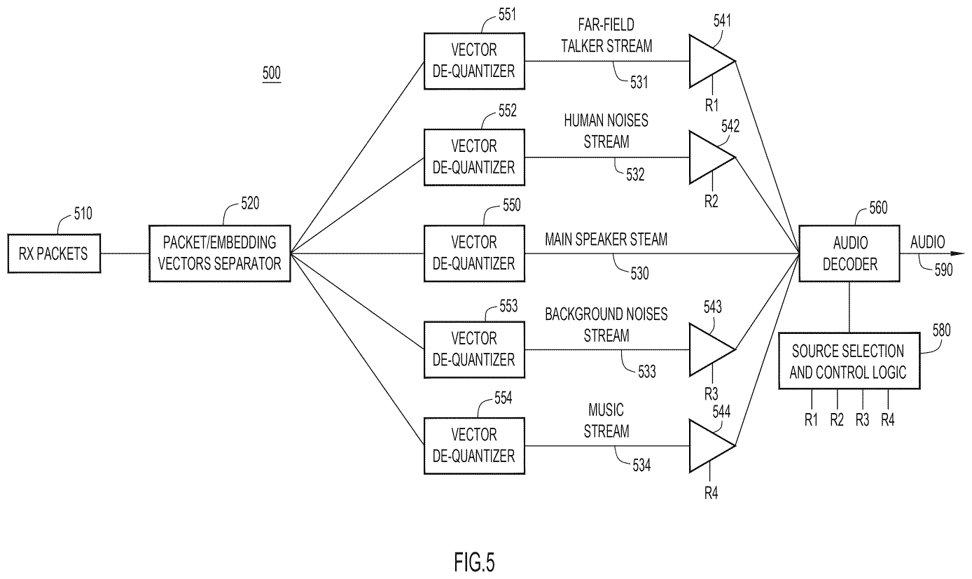

FIG. 5 is a block diagram of a receiving or remote endpoint 500 of a neural network audio codec system according to an example embodiment. RX packets 510 are received via network directly from transmitting endpoint 300 or via an intermediate server (not shown). A packet separator 520 routes all or selected packets to a respective vector de-quantizer 550, 551, 552, 553, 554. Packet separator may detect the flag or indicator provided by the outputs of vector quantizers 350, 351, 352, 353, 354.

The output of each vector de-quantizer 550, 551, 552, 553, 554 represents source separated streams in the embedding domain. Thus, in this example, remote endpoint 500 generates a reproduced main speaker stream 530, a reproduced far-field talker stream 531, a reproduced human noises stream 532, a reproduced background noises stream 533, and a reproduced music stream 534. Each of these reproduced streams may then be processed separately via filters 541, 542, 543, 544 for volume, tone, equalization, etc. Although not shown, a filter may be provided in the path of the reproduced main speaker stream 530. The filters 541, 542, 543, 544 operate in the embedding domain to adjust, e.g., volume and/or tone (or other characteristics) of each reproduced stream based on custom control via an appropriate receive control signal R1, R2, R3, R4 generated by source selection and control logic 580.

That is, source selection and control logic 580 may be configured to present to a user operating remote endpoint 500 a user interface like that shown in FIG. 4 that enables the user to de-select and/or manipulate the way in which given streams are played back as audio 590. In other words, source selection and control logic 580 enables a user to control, e.g., the volume and/or tone of each of the separated sources received at the remote endpoint.

The embedding vectors associated with each stream are then supplied to audio decoder 560, which generates audio 590 that is consistent with the customized playback selected by the user.

On the receive side (i.e., at remote endpoint 500) mixing or transform operations may be applied on the dequantized embeddings before feeding the audio decoder 560 using neural network layers with tunable parameters. However, in an alternative embodiment, these operations may be applied after each source is decoded by audio decoder 560. In the first case, only a single decoding operation is implemented, thus resulting in saved computation. In the second case, each source that is kept (selected, or not de-selected) may be decoded separately, and the desired transform may then be applied. The sources may then be mixed using, e.g., a summing node or similar mechanism.

In addition, the source separating multi-stream audio codec enables a server-side selection mechanism as well. For instance, where the transmitting endpoint 300 transmits TX packets 360 via an intermediate server, and if the transmitting endpoint 300 transmits two sources, namely the target speaker and background noise, the intermediate server may be configured to send only the bitstream of the target speaker to remote endpoint 500 that has opted for a “speaker-only” mode. Conversely, if remote endpoint 500 selects an “all-pass” mode, then the intermediate server may be configured to transmit both streams, including the target speaker and background noise. This functionality leads to improved bandwidth efficiency and cost savings and allows users to customize their audio experience.

In addition, the source separating and selection audio codecs described herein enable a fine-grained selection mechanism to be applied either in transmit side, server side or receive side. For instance, the background noises stream 333 could be classified into a number of noise categories and control logic could enable the user either at transmit, server or receive side to apply allow- and/or blocklists to allow or prohibit playing of a selected subset of such noise categories. As an example, the user at receive side could accept playing of human generated noises such as clapping, finger snapping, but could reject playing of transient noises such as hitting on the table, door slam etc. Similarly, the far-field talker stream 331 or the reproduced far-field talker stream 531 could be classified into weak and strong talkers, and the user either at the transmit or receive side might select to play only one category.

### Methods to Train the Source Separating Logic

As noted, the present embodiments rely on separating sources of interest in the latent embedding vector space at the output of source separating encoder 310. Such separation could be achieved in a number of ways during training of the neural audio codec systems. Described below are several approaches that may be used for disentangling sources in a latent embedding space.

1. The embedding vector at the output of the source separating encoder 310 may be split into as many streams as the number of sources of interest. For the sake of discussion and without loss of generality, assume that there is interest only in speech and noise. During training, the system generates the input of the codec by data augmentation, that is having a clean speech signal and a noise signal, and the system combines them at a desired level of signal to noise ratio to get the input signal. Assume that the embedding vector is of dimension D, and it is desired to have first D/2 entries to include speech information, and the last D/2 entries to include noise. The system forwards the embedding vector three times to the rest of the codec, namely, the vector quantizer and decoder. In the first pass, the approach feeds the whole embedding vector and asks the network through aforementioned loss functions to reconstruct the input mixture back again at the output of the decoder. In the second pass, the system zeros out the noise part, that is the last D/2 entries, keeping only the speech information, and asks the network through the aforementioned loss functions to reconstruct only the input clean speech at the output of the decoder. In the last pass, the system zeros out the speech part, that is the first D/2 entries, keeping only the noise information, and asks the network through the aforementioned loss functions to reconstruct only the input noise signal at the output of the decoder. As the system optimizes the network to minimize such losses in all the three cases, it enforces the network to keep speech information in the first D/2 entries, and the noise information in the last D/2 entries. Moreover, the system could enforce disentanglement of speech and noise further by swapping the noise vector with that of a different noise signal. That is, the system may create two mixtures from the same clean speech using different noise signals, for example once with traffic noise in the background and once with dog noise in the background. The system feeds the one with traffic noise through the network, but at the output of the encoder it swaps the noise subset of the embedding with the noise embedding vector of the mixture with dog noise. The system asks the network through the aforementioned loss functions to reconstruct the mixture with dog noise at the output of the decoder instead of the mixture with traffic noise due to the swapping of noise vectors in the latent embedding space. This approach is also described in: “Omran, A., Zeghidour, N., Borsos, Z., de Chaumont Quitry, F., Slaney, M., & Tagliasacchi, M. (2023 June). Disentangling speech from surroundings with neural embeddings. In ICASSP 2023-2023 IEEE International Conference on Acoustics, Speech and Signal Processing (ICASSP) (pp. 1-5)”.

2. The system could ask the respective vector quantizers 350-354 to perform the disentanglement by learning separate vector quantizers for each source and enforce additive composition at the output of the vector quantizers. For the sake of discussion and without loss of generality, assume there is interest only in speech and noise. There is a Residual Vector Quantizer (RVQ) for speech and another one for noise. Let the embedding vector be denoted as z. The system feeds the embedding vector two both of them, apply quantization and dequantization, and obtains the dequantized embedding at the output of the speech RVQ, denoted as zₛ, and obtains the dequantized embedding at the output of the noise RVQ, denoted as zₙ. The system forwards the dequantized embedding vector three times to the decoder. In the first pass, the system feeds zₛ+zₙ, the sum of the two dequantized embeddings, and asks the network through the aforementioned loss functions to reconstruct the input mixture back again at the output of the decoder. In the second pass, the system only feeds zₛ, the speech information, and asks the network through the aforementioned loss functions to reconstruct only the input clean speech at the output of the decoder. In the last pass, the system only feeds zₙ, the noise information, and asks the network through the aforementioned loss functions to reconstruct only the input noise signal at the output of the decoder. As the system optimizes the network to minimize such losses in all the three cases, it enforces the speech residual VQ to only keep speech information, and noise RVQ to only keep the noise information. This approach is also described in: “Bie, X., Liu, X., & Richard, G. (2024). Learning Source Disentanglement in Neural Audio Codec. arXiv preprint arXiv: 2409.11228.”

In accordance with the disclosed embodiments, the system may rely on a classification-based approach using the meta data about the sources used in training data augmentation and which is better suited for various control mechanisms. Assume that during training, the system generates the input of the codec by data augmentation, that is combining various source signals the system already has at hand in isolation. Assume also that the system has some meta information for these sources. For example, for speech of the main talker the system might have speaker identity, gender, phonetic content aligned with the speech etc. Similarly, for noise the system might have the noise category information. For far-field talker the system might have reverberation level information. For music, the system might know the genre of the music, etc. the system may split the embedding vector to subvectors each for a different source category. For instance, the first D/4 could be speech, the second D/4 entries could be noise, the third D/4 could be music, and the last D/4 could be far-field talker. The system could have a classifier for each of the source types that will predict the meta information available about the source in the input utterance. For example, for speech the system could have phoneme, speaker, gender, and fundamental frequency classifiers. For, music the system might have genre classifiers. For far-field talker, the system might have reverberation level classifiers, etc. As the system optimizes the network to reduce all these classification losses, it is enforcing each subvector of the embedding to hold all the information related to the associated source and not to include information on other sources so that classification becomes easy.

To further enforce the disentanglement, the system could use gradient reversal layers as described, e.g., by “Ganin, Y., & Lempitsky, V. (2015 June). Unsupervised domain adaptation by backpropagation. In International conference on machine learning (pp. 1180-1189). PMLR.”). For instance, the system can have an acoustic event classifier to predict the type of background noise, but give the speech subvector as its input. During the backpropagation of the error, the system reverses the gradient after the classifier. This way, the classifier will try to use any remaining information about the noise in the speech subvector to correctly classify the background noise and reduce the classification loss, but the encoder, taking the sign-reverted gradient will try to increase the classification loss by not putting any information regarding noise in the speech subvector.

Note that the classifiers described here for achieving disentanglement could also be used in building the logic on each of the sending and receive sides. For example, the selective playing of certain noise types, music types, or far-field talkers based on distance and reverb level could be based on using such classifiers. If the classifier estimates that the noise type is an impulsive noise and the user decides to not send it, the system can stop quantizing and sending the noise subvectors and use the bandwidth for the other sources. To have the same logic on the receive side, the system can train the classifiers by the dequantized embeddings at the receive side to be given as input to the decoder.

### Methods to Implement Transform and Filtering Logic

The system may also apply transforms to the embedding subvectors corresponding to the sources present in the utterance to get some desired response at the output of the decoder. Such transforms could be achieved by applying a machine learning based subnetwork, such as a neural network to the embedding subvector streams and try to regress the desired output at the decoder output and enforcing this with the aforementioned loss functions. For example, the system can include a small subnetwork that takes the embedding subvector and a desired output level indicator vector and transforms the embedding subvector such that the decoder output level changes accordingly. Assume that zₘ is the music subvector sequence. Assume that the system discretized the output level into 20 levels in dB scale and l is a binary one-hot vector of dimension 20 having only a single one for the desired level and all the other entries are 0. The system can apply the below affine transform to get the transformed embedding zₘₗ:

$${z}_{m l} = {W}_{z} {z}_{m} + {W}_{l} l + b$$

The system feeds zₘₗ to the decoder and compares it with the reference audio that has the desired level for the music and enforces the affine transform to create the desired response with the aforementioned losses. Here, the matrices <W_{z}, Wₗ> and the bias vector b are the learned parameters to achieve the desired level transform.

Similar transforms using various neural networks layers could be trained to enable other transforms such as applying certain low pass/high pass/bandpass filters to the sources.

Thus, as explained herein, separating received audio into sound sources, or distinct streams, (by content, and in the embedding (latent) domain) enables the system to optionally filter some of the streams or apply a transform such as amplifying or reducing the gain of selected sources either on the transmit or receive side as well as using different bitrates per source stream depending on user preferences, network conditions and their information content. In this sense, the system can use the available bandwidth more efficiently and use a variable bitrate scheme depending on the current content. Depending on which sources, or streams, are present at a given time, the bandwidth assigned to a given source could be increased or decreased.

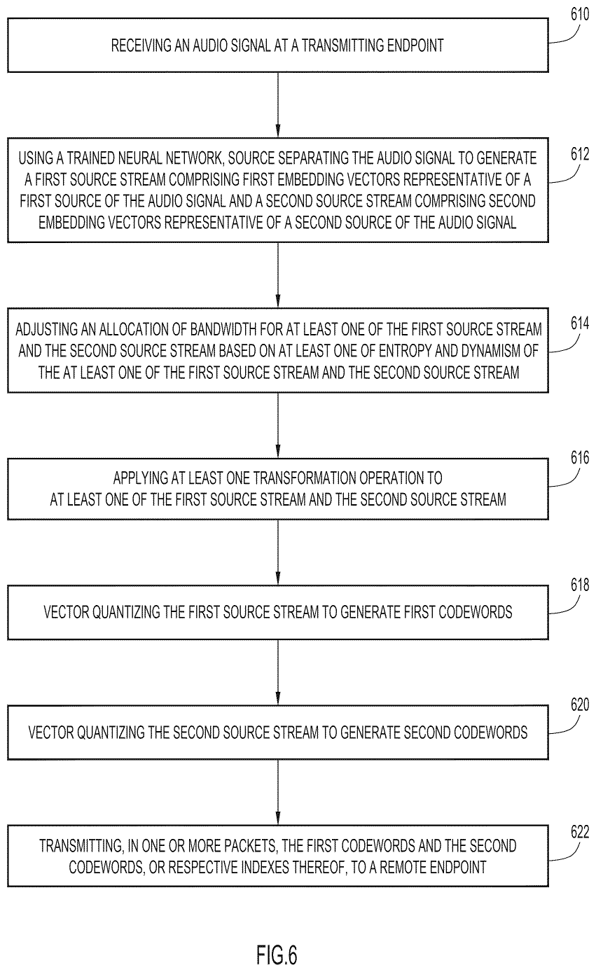

FIG. 6 is a flowchart depicting a series of operations that may be executed by a transmitting endpoint in connection with source separating and control logic 180, according to an example embodiment. At 610, an operation includes receiving an audio signal at a transmitting endpoint. At 612, an operation includes using a trained neural network, source separating the audio signal to generate a first source stream comprising first embedding vectors representative of a first source of the audio signal and a second source stream comprising second embedding vectors representative of a second source of the audio signal. At 614, an operation includes adjusting an allocation of bandwidth for at least one of the first source stream and the second source stream based on at least one of entropy and dynamism of the at least one of the first source stream and the second source stream. At 616, an operation includes applying at least one transformation operation to at least one of the first source stream and the second source stream. At 618, an operation includes vector quantizing the first source stream to generate first codewords. At 620, an operation includes vector quantizing the second source stream to generate second codewords. And, at 622, an operation includes transmitting, in one or more packets, the first codewords and the second codewords, or respective indexes thereof, to a remote endpoint.

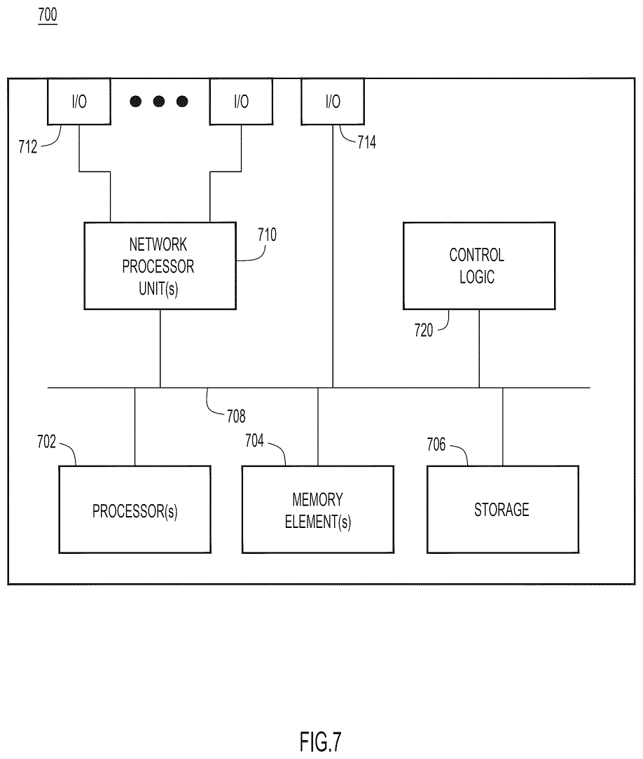

FIG. 7 is a block diagram of a computing device that may be configured to host a source separating encoder 310, source separating and control logic 180, and/or source selection and control logic 580, and to perform techniques described herein, according to an example embodiment. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving an audio signal at a transmitting endpoint, using a trained neural network, source separating the audio signal to generate a first source stream comprising first embedding vectors representative of a first source of the audio signal and a second source stream comprising second embedding vectors representative of a second source of the audio signal, adjusting an allocation of bandwidth for at least one of the first source stream and the second source stream based on at least one of entropy and dynamism of the at least one of the first source stream and the second source stream, applying at least one transformation operation to at least one of the first source stream and the second source stream, vector quantizing the first source stream to generate first codewords, vector quantizing the second source stream to generate second codewords, and transmitting, in one or more packets, the first codewords and the second codewords, or respective indexes thereof, to a remote endpoint.

The method may further include using the trained neural network, source separating the audio signal to generate a third source stream comprising third embedding vectors representative of a third source of the audio signal, and at least one of selecting the third source stream to not send to the remote endpoint and adjusting an allocation of bandwidth for the third source stream.

The method may also include allocating an increased amount of bandwidth to at least one of the first source stream and the second source stream in response to at least one of the third source stream not being sent to the remote endpoint and the allocation of bandwidth for the third source stream being reduced.

The method may further include adjusting an amount of bandwidth allocated to at least one of the first source stream and the second source stream in response to receiving information regarding a channel condition between the transmitting endpoint and the remote endpoint.

In the method, applying the at least one transformation operation to the at least one of the first source stream and the second source stream may include controlling at least one of volume, tone, and temporal and spectral characteristics for at least one of the first source stream and the second source stream.

In the method, applying the at least one transformation operation to the at least one of the first source stream and the second source stream may be in response to input received via a user interface.

The method may further include passing the at least one of the first source stream and the second source stream through a classifier.

In the method, the first source of the audio signal may include a main speaker and wherein the second source of the audio signal may include at least one of a far-field talker, human noises, background noises, and music.

The method may further include, in response to receiving user input at the remote endpoint, selecting at least one of a reproduced first source stream and a reproduced second source stream to not play back as audio.

The method may also include, in response to receiving user input at the remote endpoint, applying at least one transformation operation to at least one of a reproduced first source stream and a reproduced second source stream, wherein the at least one transformation operation is executed in an embedding domain prior to decoding the reproduced first source stream and the reproduced second source stream.

In another embodiment, a device may be provided and may include an interface configured to enable network communications, a memory, and one or more processors coupled to the interface and the memory, and configured to: receive an audio signal, using a trained neural network, source separate the audio signal to generate a first source stream comprising first embedding vectors representative of a first source of the audio signal and a second source stream comprising second embedding vectors representative of a second source of the audio signal, adjust an allocation of bandwidth for at least one of the first source stream and the second source stream based on at least one of entropy and dynamism of the at least one of the first source stream and the second source stream, apply at least one transformation operation to at least one of the first source stream and the second source stream, vector quantize the first source stream to generate first codewords, vector quantize the second source stream to generate second codewords, and transmit, in one or more packets, the first codewords and the second codewords, or respective indexes thereof, to a remote endpoint.

In the device, the one or more processors may be configured to: using the trained neural network, source separate the audio signal to generate a third source stream comprising third embedding vectors representative of a third source of the audio signal; and at least one of select the third source stream to not send to the remote endpoint and adjust an allocation of bandwidth for the third source stream.

In the device, the one or more processors may be configured to allocate an increased amount of bandwidth for at least one of the first source stream and the second source stream in response to at least one of the third source stream not being sent to the remote endpoint and the allocation of bandwidth for the third source stream being reduced.

In the device, the one or more processors may be configured to adjust an amount of bandwidth allocated for at least one of the first source stream and the second source stream in response to receiving information regarding a channel condition between the device and the remote endpoint.

In the device, the one or more processors may be configured to apply the at least one transformation operation to the at least one of the first source stream and the second source stream by controlling at least one of volume, tone and temporal and spectral characteristics for at least one of the first source stream and the second source stream.

In the device, the one or more processors may be configured to apply the at least one transformation operation to the at least one of the first source stream and the second source stream is in response to input received via a user interface.

In yet another embodiment, one or more non-transitory computer readable storage media encoded with instructions are provided and that, when executed by a processor, cause the processor to: receive an audio signal at a transmitting endpoint, using a trained neural network, source separate the audio signal to generate a first source stream comprising first embedding vectors representative of a first source of the audio signal and a second source stream comprising second embedding vectors representative of a second source of the audio signal, adjust an allocation of bandwidth for at least one of the first source stream and the second source stream based on at least one of entropy and dynamism of the at least one of the first source stream and the second source stream, apply at least one transformation operation to at least one of the first source stream and the second source stream, vector quantize the first source stream to generate first codewords, vector quantize the second source stream to generate second codewords, and transmit, in one or more packets, the first codewords and the second codewords, or respective indexes thereof, to a remote endpoint.

The instructions may be configured to, using the trained neural network, source separate the audio signal to generate a third source stream comprising third embedding vectors representative of a third source of the audio signal, and at least one of select the third source stream to not send to the remote endpoint and adjust an allocation of bandwidth for the third source stream.

The instructions may be configured to allocate an increased amount of bandwidth for at least one of the first source stream and the second source stream in response to at least one of the third source stream not being sent to the remote endpoint and the allocation of bandwidth for the third source stream being reduced.

The instructions may be configured to adjust an amount of bandwidth allocated for at least one of the first source stream and the second source stream in response to receiving information regarding a channel condition between the transmitting endpoint and the remote endpoint.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving an audio signal at a transmitting endpoint;
using a trained neural network, source separating the audio signal to generate a first source stream comprising first embedding vectors representative of a first source of the audio signal and a second source stream comprising second embedding vectors representative of a second source of the audio signal;
adjusting an allocation of bandwidth for at least one of the first source stream and the second source stream based on at least one of entropy and dynamism of the at least one of the first source stream and the second source stream;
applying at least one transformation operation to at least one of the first source stream and the second source stream;
vector quantizing the first source stream to generate first codewords;
vector quantizing the second source stream to generate second codewords; and
transmitting, in one or more packets, the first codewords and the second codewords, or respective indexes thereof, to a remote endpoint.

2. The method of claim 1, further comprising:
using the trained neural network, source separating the audio signal to generate a third source stream comprising third embedding vectors representative of a third source of the audio signal; and
at least one of selecting the third source stream to not send to the remote endpoint and adjusting an allocation of bandwidth for the third source stream.

3. The method of claim 2, further comprising allocating an increased amount of bandwidth to at least one of the first source stream and the second source stream in response to at least one of the third source stream not being sent to the remote endpoint and the allocation of bandwidth for the third source stream being reduced.

4. The method of claim 1, further comprising adjusting an amount of bandwidth allocated to at least one of the first source stream and the second source stream in response to receiving information regarding a channel condition between the transmitting endpoint and the remote endpoint.

5. The method of claim 1, wherein applying the at least one transformation operation to the at least one of the first source stream and the second source stream comprises controlling at least one of volume, tone, and temporal and spectral characteristics for at least one of the first source stream and the second source stream.

6. The method of claim 5, wherein applying the at least one transformation operation to the at least one of the first source stream and the second source stream is in response to input received via a user interface.

7. The method of claim 1, further comprising passing the at least one of the first source stream and the second source stream through a classifier.

8. The method of claim 7, wherein the first source of the audio signal comprises a main speaker and wherein the second source of the audio signal comprises at least one of a far-field talker, human noises, background noises, and music.

9. The method of claim 1, further comprising:
in response to receiving user input at the remote endpoint, selecting at least one of a reproduced first source stream and a reproduced second source stream to not play back as audio.

10. The method of claim 1, further comprising:
in response to receiving user input at the remote endpoint, applying at least one transformation operation to at least one of a reproduced first source stream and a reproduced second source stream, wherein the at least one transformation operation is executed in an embedding domain prior to decoding the reproduced first source stream and the reproduced second source stream.

11. A device comprising:
an interface configured to enable network communications;
a memory; and
one or more processors coupled to the interface and the memory, and configured to:
receive an audio signal;
using a trained neural network, source separate the audio signal to generate a first source stream comprising first embedding vectors representative of a first source of the audio signal and a second source stream comprising second embedding vectors representative of a second source of the audio signal;
adjust an allocation of bandwidth for at least one of the first source stream and the second source stream based on at least one of entropy and dynamism of the at least one of the first source stream and the second source stream;
apply at least one transformation operation to at least one of the first source stream and the second source stream;
vector quantize the first source stream to generate first codewords;
vector quantize the second source stream to generate second codewords; and
transmit, in one or more packets, the first codewords and the second codewords, or respective indexes thereof, to a remote endpoint.

12. The device of claim 11, wherein the one or more processors are configured to:
using the trained neural network, source separate the audio signal to generate a third source stream comprising third embedding vectors representative of a third source of the audio signal; and
at least one of select the third source stream to not send to the remote endpoint and adjust an allocation of bandwidth for the third source stream.

13. The device of claim 12, wherein the one or more processors are configured to allocate an increased amount of bandwidth for at least one of the first source stream and the second source stream in response to at least one of the third source stream not being sent to the remote endpoint and the allocation of bandwidth for the third source stream being reduced.

14. The device of claim 11, wherein the one or more processors are configured to adjust an amount of bandwidth allocated for at least one of the first source stream and the second source stream in response to receiving information regarding a channel condition between the device and the remote endpoint.

15. The device of claim 11, wherein the one or more processors are configured to apply the at least one transformation operation to the at least one of the first source stream and the second source stream by controlling at least one of volume, tone and temporal and spectral characteristics for at least one of the first source stream and the second source stream.

16. The device of claim 15, wherein the one or more processors are configured to apply the at least one transformation operation to the at least one of the first source stream and the second source stream is in response to input received via a user interface.

17. One or more non-transitory computer readable storage media encoded with instructions that, when executed by a processor, cause the processor to:
receive an audio signal at a transmitting endpoint;
using a trained neural network, source separate the audio signal to generate a first source stream comprising first embedding vectors representative of a first source of the audio signal and a second source stream comprising second embedding vectors representative of a second source of the audio signal;
adjust an allocation of bandwidth for at least one of the first source stream and the second source stream based on at least one of entropy and dynamism of the at least one of the first source stream and the second source stream;
apply at least one transformation operation to at least one of the first source stream and the second source stream;
vector quantize the first source stream to generate first codewords;
vector quantize the second source stream to generate second codewords; and
transmit, in one or more packets, the first codewords and the second codewords, or respective indexes thereof, to a remote endpoint.

18. The one or more non-transitory computer readable storage media of claim 17, wherein the instructions are configured to:
using the trained neural network, source separate the audio signal to generate a third source stream comprising third embedding vectors representative of a third source of the audio signal; and
at least one of select the third source stream to not send to the remote endpoint and adjust an allocation of bandwidth for the third source stream.

19. The one or more non-transitory computer readable storage media of claim 18, wherein the instructions are configured to allocate an increased amount of bandwidth for at least one of the first source stream and the second source stream in response to at least one of the third source stream not being sent to the remote endpoint and the allocation of bandwidth for the third source stream being reduced.

20. The one or more non-transitory computer readable storage media of claim 17, wherein the instructions are configured to adjust an amount of bandwidth allocated for at least one of the first source stream and the second source stream in response to receiving information regarding a channel condition between the transmitting endpoint and the remote endpoint.
